(19) United States
(12) Patent Application Publication
(10) Pub. No.: US 2025/0271599 A1
(43) Pub. Date: Aug. 28, 2025

(54) WINDOW AND METHOD OF PROVIDING THE SAME

(71) Applicant: Samsung Display Co., LTD.

(72) Inventors: DONG-SUNG LEE, Suwon-si (KR); YONGKYU KANG, Hwaseong-si (KR); JIHYUN KO, Suwon-si (KR); HYUNSEUNG SEO, Gwacheon-si (KR); HUI YEON SHON, Seongnam-si (KR); HYUNKYUNG YUN, Namyangju-si (KR)

(21) Appl. No.: 19/207,585

(22) Filed: May 14, 2025

Related U.S. Application Data
(62) Division of application No. 17/199,575, filed on Mar. 12, 2021.

(30) Foreign Application Priority Data
Jun. 30, 2020 (KR) 10-2020-0080247

(51) Int. Cl. G02B 1/14

(52) U.S. Cl. CPC G02B 1/14

(57) ABSTRACT

A method of manufacturing a window includes providing a base substrate and a protective film each including an upper surface and a lower surface, providing the upper surface of the protective film removably attached to the lower surface of the base substrate, providing a processed base substrate and a processed protective film by removing portions of the base substrate and the protective film to provide an exposed upper surface of the processed protective film which is closer to the lower surface thereof than the upper surface thereof, providing a first surface protection layer on both the upper surface of the processed base substrate and the exposed upper surface of the processed protective film, and providing the processed protective film separated from the processed base substrate to provide the window which is attachable to a display device and includes the processed base substrate having the first surface protection layer.

This application is a divisional application of U.S. application Ser. No. 17/199,575 filed Mar. 12, 2021, which claims priority to Korean Patent Application No. 10-2020-0080247, filed on Jun. 30, 2020, and all the benefits accruing therefrom under 35 U.S.C. § 119, the contents of which are hereby incorporated by reference in its entirety.

### BACKGROUND

### 1. Field

The disclosure relates to a window and a method of providing the same. More particularly, the disclosure relates to a window of an electronic display device including a hard coating layer and a method of providing the window.

### 2. Description of the Related Art

An electronic apparatus that provides images, such as a display monitor, a smartphone, a tablet computer or the like, includes a display device and a window. The display device generates the images, and the window transmits the images generated by the display device to outside the electronic apparatus and protects the display device. The window has a level of hardness to protect the display device, and to this end, the window includes a hard coating layer.

With the technological development of the display device, a curved display device including an edge area is being developed. The curved display device includes a front surface having a flat shape and a side surface which has a curved shape at the edge area. The window of the display device including a curved side surface protects both the front surface and the side surface.

### SUMMARY

One or more embodiment provides a window including a hard coating layer on a side surface of an electronic device which is curved.

One or more embodiment provides a method of manufacturing or providing the window having a hard coating layer corresponding to the curved side surface of the window.

Embodiments provide a method of providing a window. The method of providing the window includes providing a base substrate including a first upper surface and a first lower surface opposing the first upper surface, providing a protective film including a second upper surface and a second lower surface opposing the second upper surface, providing the second upper surface of the protective film removably attached to the first lower surface of the base substrate, providing a processed base substrate and a processed protective film by removing a portion of the base substrate and a portion of the protective film to provide an exposed upper surface of the processed protective film which is between the second lower surface than the second upper surface, providing a first surface protection layer on both the first upper surface of the processed base substrate and the exposed upper surface of the processed protective film, and providing the processed protective film separated from the processed base substrate to provide the window which is attachable to a display device of the electronic apparatus and includes the processed base substrate having the first surface protection layer.

The removing of the portion of the base substrate and the portion of the protective film may include defining within the processed base substrate a width of the first upper surface which is smaller than a width of the first lower surface, and a side surface which connects the first upper surface and the first lower surface to each other, and defining within the processed protective film an overlap portion which corresponds to the width of the first lower surface of the processed base substrate, a non-overlap portion which extends further than the width of the first lower surface of the processed base substrate and defines the exposed upper surface of the processed protective film, and an exposed side surface which connects the exposed upper surface to the second upper surface.

The providing of the first surface protection layer may include providing a protection layer material on the first upper surface and the side surface of the processed base substrate and on the non-overlap portion and the exposed side surface of the processed protective film, and curing the protection layer material.

The providing of the protection layer material may include a spraying method or a slit coating method.

The curing of the protection layer material may include a heat curing method or an ultraviolet curing method.

The providing of the processed protective film separated from the processed base substrate may include separating from the processed base substrate having the first surface protection layer, both the non-overlap portion together with the protection layer material which is cured on the non-overlap portion and on the exposed side surface of the processed protective film, and the overlap portion.

The method may further include after the providing of the first surface protection layer, providing a second surface protection layer on the first surface protection layer, where the second surface protection layer is further from the first lower surface of the processed base substrate than the first surface protection layer.

The method may further include after the providing of the processed protective film separated from the processed base substrate, providing a third coating layer on the first lower surface of the processed base substrate.

Embodiments provide a window of an electronic apparatus, including a base substrate including an upper surface which corresponds to a transmission area of a display device of the electronic apparatus, a lower surface facing the upper surface, and a side surface which corresponds to a bezel area of the display device and connects the upper surface and the lower surface to each other, and a first surface protection layer on the upper surface and the side surface of the base substrate. The first surface protection layer includes a first portion on the upper surface and having a first thickness, and a second portion on the side surface and having a second thickness different from the first thickness. The first thickness and the second thickness are minimum distances in a normal line direction with respect to the upper surface and the side surface, respectively.

The side surface may include a curved surface.

The upper surface may have a width smaller than a width of the lower surface.

The side surface may have a width that decreases from the lower surface toward the upper surface.

The base substrate may include a polymer resin.

The first portion may have a hardness corresponding to a pencil hardness equal to or greater than about 8 H and equal to or smaller than about 9 H.

A ratio of the second thickness to the first thickness may be equal to or greater than about 0.5 and smaller than about 1.

The first thickness may be equal to or greater than about 20 micrometers and equal to or smaller than about 50 micrometers, and the second thickness may be equal to or greater than about 10 micrometers and equal to or smaller than about 25 micrometers.

The second portion may have a thickness which decreases from the upper surface toward the lower surface.

The window may further include a second surface protection layer on the first portion.

The window may further include a third surface protection layer under the lower surface.

The third surface protection layer has a thickness equal to or greater than about 1 micrometer and equal to or smaller than about 10 micrometers.

According to one or more embodiment of the method of providing the window, the protective film includes the exposed upper surface having the difference in height with respect to the attachment surface between the base substrate and the protective film, and thus, the first surface protection layer is stably on the side surface of the base substrate.

In addition, according to one or more embodiment of the window, the first surface protection layer has different thicknesses at the upper surface and the side surface of the base substrate, and thus, damage to the first surface protection layer is reduced or effectively prevented.

### BRIEF DESCRIPTION OF THE DRAWINGS

The above and other advantages of the invention will become readily apparent by reference to the following detailed description when considered in conjunction with the accompanying drawings where:

FIG. 1 is a perspective view showing an embodiment of an electronic apparatus;

FIG. 2 is an exploded perspective view showing an embodiment of an electronic apparatus;

FIG. 3A is a plane view showing an embodiment of a window;

FIG. 3B is a cross-sectional view showing an embodiment of a window;

FIG. 4 is a flowchart showing an embodiment of a method of providing a window;

FIG. 5 is a cross-sectional view showing an embodiment of a base substrate;

FIG. 6 is a cross-sectional view showing an embodiment of a base substrate to which a protective film is removably attachable;

FIG. 7A is a flowchart showing an embodiment of processing a protective film and a base substrate;

FIG. 7B is a cross-sectional view showing an embodiment of a processed base substrate and a processed protective film;

FIG. 8A is a flowchart showing an embodiment of providing a first hard coating layer;

FIG. 8B is a cross-sectional view showing an embodiment of a processed base substrate and a processed protective film having a first hard coating layer;

FIG. 9A is a flowchart showing an embodiment of providing a processed protective film removed from a processed base substrate;

FIG. 9B is a cross-sectional view showing a processed base substrate from which a processed protective film is separated;

FIG. 10A is a flowchart showing an embodiment of a method of providing a window including a second hard coating layer;

FIG. 10B is a cross-sectional view showing an embodiment of a processed base substrate having a second hard coating layer;

FIG. 11A is a flowchart showing an embodiment of a method of providing a window including a third hard coating layer;

FIG. 11B is a cross-sectional view showing an embodiment of a processed base substrate having a third hard coating layer;

FIG. 12 is an enlarged cross-sectional view showing a portion of an embodiment of a window having a first hard coating layer;

FIG. 13 is an enlarged cross-sectional view showing a portion of an embodiment of a window having a second hard coating layer; and

FIG. 14 is an enlarged cross-sectional view showing a portion of an embodiment of a window having a third hard coating layer.

### DETAILED DESCRIPTION

In the disclosure, it will be understood that when an element or layer is referred to as being related to another element such as being “on,” “connected to” or “coupled to” another element or layer, it can be directly on, connected or coupled to the other element or layer or intervening elements or layers may be present. In contrast, when an element or layer is referred to as being related to another element such as being “directly on,” “directly connected to” or “directly coupled to” another element or layer, no other element or layer or intervening elements or layers are present.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like numerals refer to like elements throughout. In the drawings, the thickness, ratio, and dimension of components are exaggerated for effective description of the technical content.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. As used herein, the singular forms, “a”, “an” and “the” are intended to include the plural forms as well, unless the context clearly indicates otherwise. “At least one” is not to be construed as limiting “a” or “an.” “Or” means “and/or.” As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Hereinafter, a window WM of an electronic apparatus EA and a method of providing the window WM will be explained in detail with reference to the accompanying drawings.

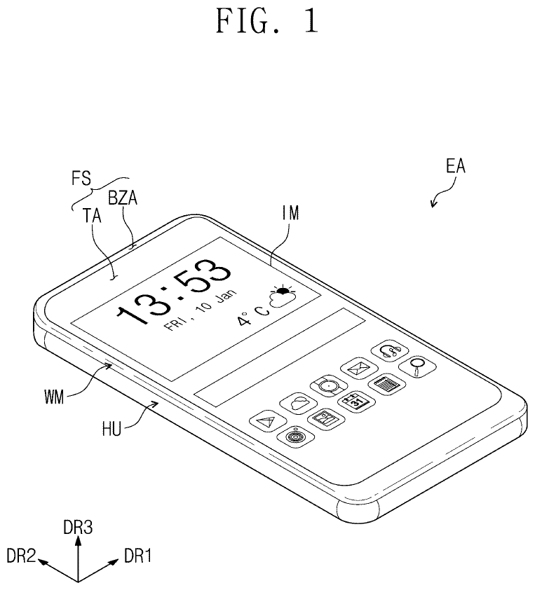

FIG. 1 is a perspective view showing an embodiment an electronic apparatus EA. The electronic apparatus EA may be an apparatus that is activated in response to electrical signals applied thereto. The electronic apparatus EA may include various embodiments. In an embodiment, for example, the electronic apparatus EA may include a tablet computer, a notebook computer or a smart television. In the follow description, a smartphone will be described as a representative example of the electronic apparatus EA.

The electronic apparatus EA displays an image IM through a transmission area TA. The image IM includes at least one of a still image and a motion image. FIG. 1 shows a clock widget and application icons as representative examples of the image IM.

The transmission area TA may have a quadrangular planar shape in a plane which is substantially parallel to a plane defined by a first directional axis DR1 (e.g., first direction) and a second directional axis DR2 (e.g., second direction) crossing each other, however, is not limited thereto. The transmission area TA may include a variety of planar shapes and should not be particularly limited.

A bezel area BZA is defined adjacent to the transmission area TA. In an embodiment, the bezel area BZA surrounds the transmission area TA. The transmission area TA and the bezel area BZA may together define a front surface FS (e.g., display surface) of the electronic apparatus EA. Various layers or components of the electronic apparatus EA may include a transmission area TA and a bezel area BZA corresponding to those features described above.

A normal line direction of the front surface FS corresponds to a thickness direction (hereinafter, referred to as a “third directional axis DR3”) of the electronic apparatus EA. In the disclosure, front (or upper) and rear (or lower) surfaces of each member are defined with respect to a direction in which the image IM is displayed. The front and rear surfaces are opposite to each other along the third directional axis DR3.

Hereinafter, first, second and third directions are respectively indicated by the first, second and third directional axes DR1, DR2 and DR3 and assigned with the same reference numerals as the first, second and third directional axes DR1, DR2 and DR3. The directions indicated by the first, second and third directional axes DR1, DR2 and DR3 are relative to each other and may be changed to other directions.

The electronic apparatus EA may have an appearance that is defined by a window WM and an external case HU. The front surface FS of the electronic apparatus EA may be defined in and/or by the window WM.

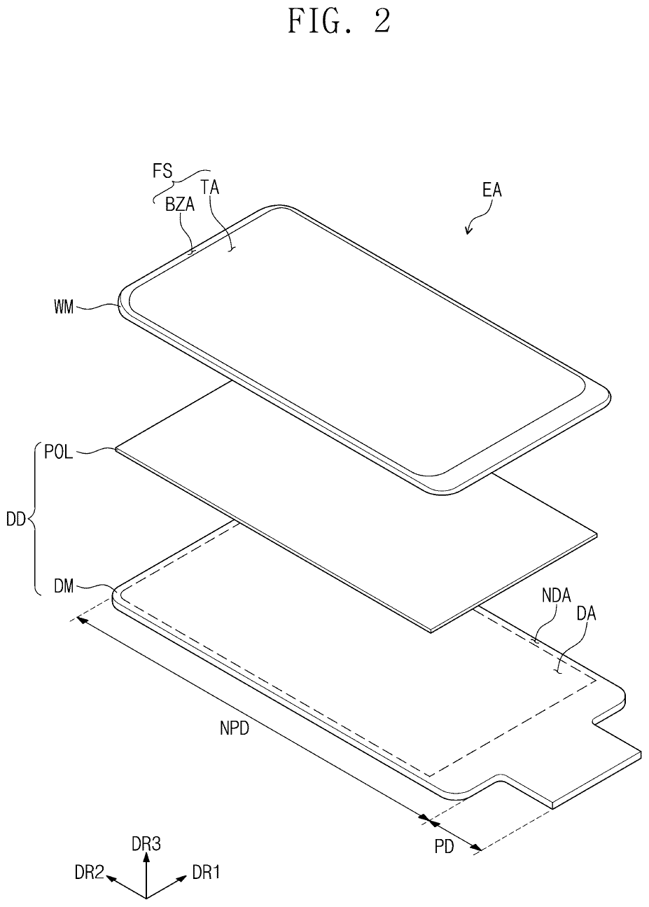

FIG. 2 is an exploded perspective view showing the electronic apparatus EA in FIG. 1. Referring to FIG. 2, the electronic apparatus EA includes a display device DD and the window WM facing the display device DD. The display device DD includes a polarizing module POL (e.g., polarizing member or polarizing layer) and a display module DM facing the polarizing module POL. The window WM, the polarizing module POL and the display module DM are each disposed in a plane which is substantially parallel to a plane defined by the first directional axis DR1 and the second directional axis DR2 crossing each other. The window WM, the polarizing module POL and the display module DM face each other and are stacked in a direction substantially parallel to the third directional axis DR3.

The display module DM may include a display area DA at which an image IM is generated and/or displayed, at which light is generated and/or emitted, etc. The transmission area TA may correspond to the display area DA. The display module DM may include a non-display area NDA adjacent to the display area DA. The bezel area BZA may correspond to the non-display area NDA. The display module DM may further include a pad area PD which includes one or more pad at which the display module DM is connected to an external device (e.g., circuit board, flexible film, etc.), and a non-pad area NPD which is adjacent to the pad area PD. The non-pad area NPD may include the display area DA and a portion of the non-display area NDA.

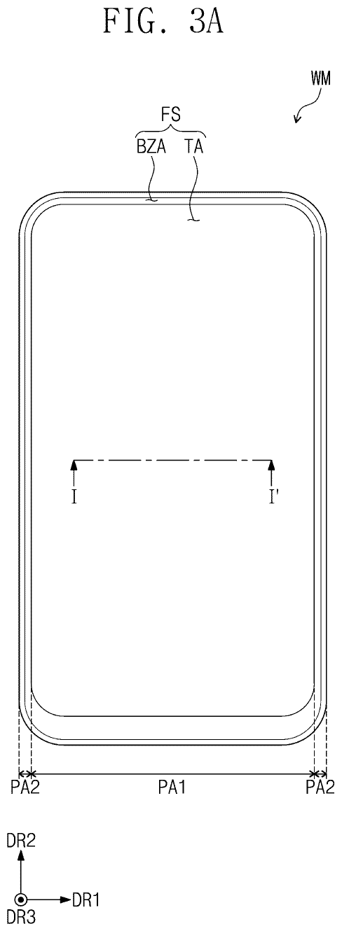

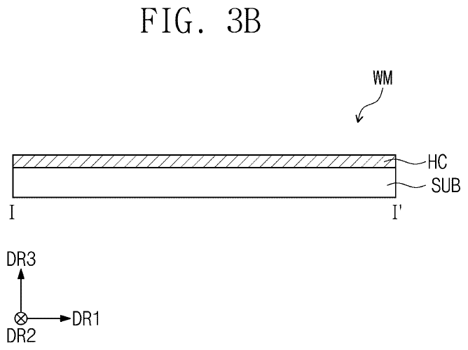

FIG. 3A is a plane view showing an embodiment of the window WM, and FIG. 3B is a cross-sectional view showing the window WM taken along line I-I′ of FIG. 3A.

Referring to FIG. 3A, the window WM includes a first portion PA1 and a second portion PA2. The second portion PA2 is a portion disposed outside the first portion PA1. The first portion PA1 and the second portion PA2 will be described in detail later. Various layers or components of the window WM may include a first portion PA1 and a second portion PA2 corresponding to those features described above.

Referring to FIG. 3B, the window WM includes a base substrate SUB and a hard coating layer HC (e.g., surface protection layer) disposed on the base substrate SUB to face the base substrate SUB. Although not shown in figures, the window WM may further include at least one functional layer in addition to the hard coating layer HC, on the base substrate SUB. In an embodiment, for example, the window WM may further include an anti-fingerprint layer, a protective layer and/or an anti-static layer, however, should not be limited thereto or thereby. The functional layer disposed on the base substrate SUB may be implemented in a single layer with multiple functions or in a plurality of layers with different functions from each other. The window WM may include the hard coating layer HC disposed not only on an upper surface of the base substrate SUB which is furthest in the third directional axis DR3 but also on a side surface SA1 of the base substrate SUB which is furthest along the first directional axis DR1. The window WM will be described in detail later.

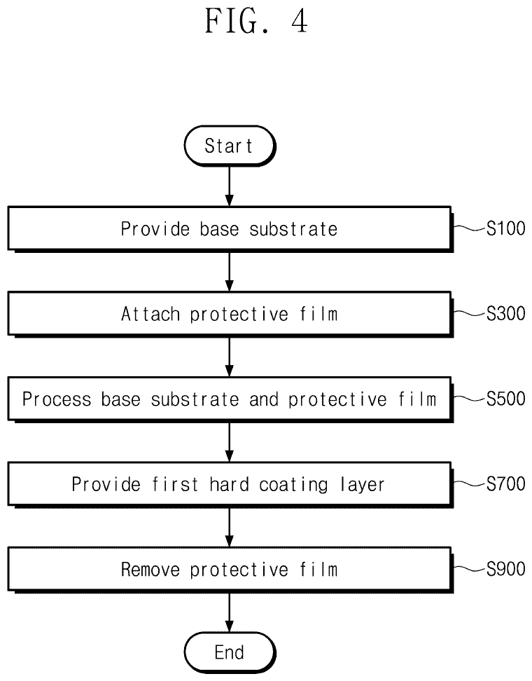

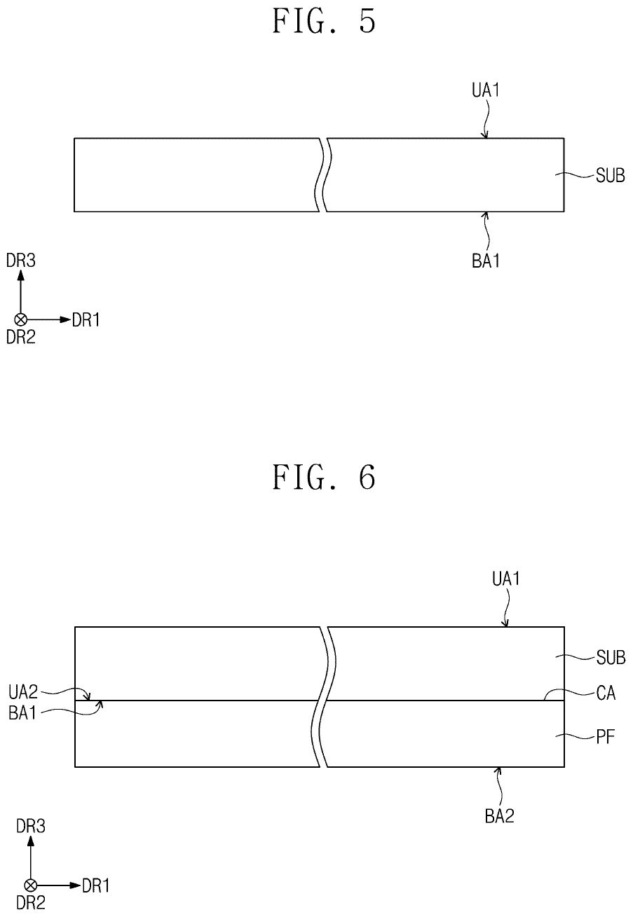

FIG. 4 is a flowchart showing an embodiment of a method of providing the window WM. The method of providing the window WM includes providing the base substrate SUB (S100), removably attaching a protective film PF (S300), processing the base substrate SUB having the protective film PF (S500), providing a first hard coating layer HC1 (S700), and removing the protective film PF (S900). Hereinafter, the method of providing the window WM will be described in detail with reference to FIGS. 5 to 12.

FIG. 5 shows an embodiment of the providing of the base substrate SUB (S100). The base substrate SUB which is unprocessed (e.g., preliminary base substrate) includes a first upper surface UA1 (e.g., upper surface) and a first lower surface BA1 (e.g., lower surface) which faces the first upper surface UA1 to be opposite thereto along the third directional axis DR3. The first upper surface UA1 and the first lower surface BA1 are distinguished from each other with respect to the third directional axis DR3. The first upper surface UA1 is described as being defined as a surface exposed outside the base substrate SUB in a direction in which the third directional axis DR3 extends, and the first lower surface BA1 is described as being defined as a surface exposed to outside the base substrate SUB in a direction opposite to the direction in which the third directional axis DR3 extends.

The base substrate SUB includes a polymer resin with a light transmissivity. The base substrate SUB includes at least one of polyethylene (“PET”), polypropylene (“PP”), polyamide (“PAM”), polyacetal (“POM”), polycarbonate (“PC)”, polymethyl methacrylate (“PMMA”), polybutylene terephthalate (“PBT”), polycarbonate blend series, cellulose, moisture-proof cellophane, and low refractive index resin. However, material of the base substrate SUB should not be limited thereto or thereby.

FIG. 6 shows an embodiment of the providing of the protective film PF (S300). The protective film PF which is unprocessed (e.g., preliminary protective film) is provided on the first lower surface BA1 of the base substrate SUB such as being removably attached thereto. The protective film PF is attachable to and removable from the base substrate SUB. The protective film PF includes a second upper surface UA2 and a second lower surface BA2 facing the second upper surface UA2. The protective film PF is provided such that the second upper surface UA2 of the protective film PF is in contact with the first lower surface BA1 of the base substrate SUB. A surface or interface at which the first lower surface BA1 of the base substrate SUB is in contact with the second upper surface UA2 of the protective film PF is referred to as an attachment surface CA. The base substrate SUB and the protective film PF may contact each other along a plane parallel to a plane defined by the first directional axis DR1 and the second directional axis DR2, to define a contact area or attachment area.

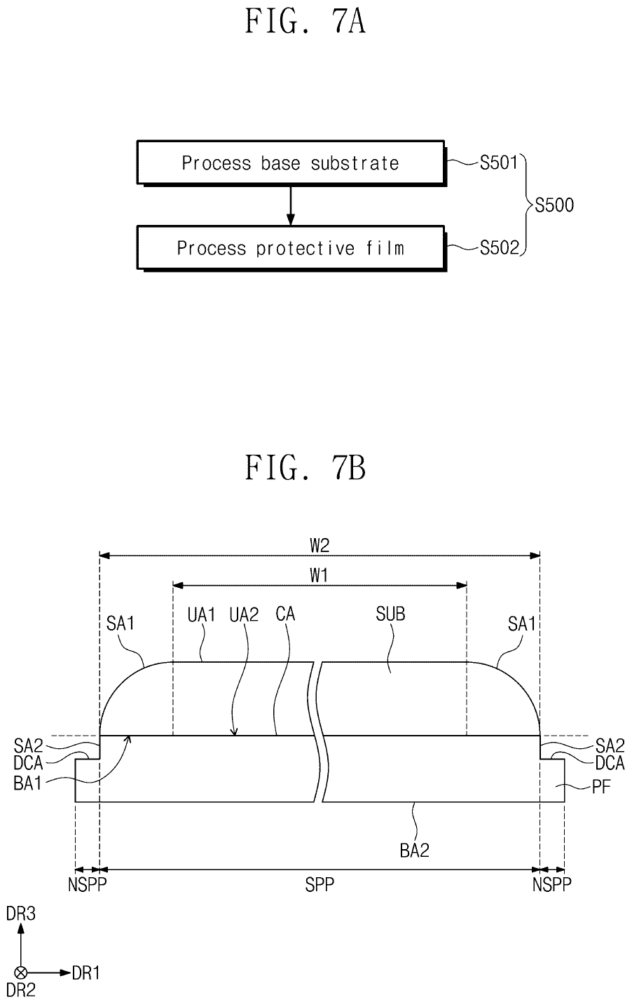

FIG. 7A is a flowchart showing an embodiment of the processing of the base substrate SUB and the protective film PF (S500), and FIG. 7B shows an embodiment of a structure including the base substrate SUB which is processed (e.g., processed base substrate) and the protective film PF which is processed (e.g., processed protective film) according to FIG. 7A. The structure in FIG. 7B including the base substrate SUB and the protective film PF includes the structure in FIG. 6 which is processed. Side surfaces of the base substrate SUB and the protective film PF in FIG. 6 are substantially flat and may be aligned with each other (e.g., coplanar with each other) along the third directional axis DR3.

Referring to FIGS. 7A and 7B, the processing of the base substrate SUB and the protective film PF (S500) includes processing of the base substrate SUB (S501) and processing of the protective film PF (S502). The base substrate SUB and the protective film PF may be processed together. The processing of the base substrate SUB (S501) includes forming a side surface SA1 disposed between the first upper surface UA1 and the first lower surface BA1. The side surface SA1 connects the first upper surface UA1 and the first lower surface BA1 to each other. The side surface SA1 is provided in plural disposed at opposite ends of the first upper surface UA1 with the first upper surface UA1 interposed therebetween. The first upper surface UA1 includes a flat surface, and the side surface SA1 includes a curved surface. The first upper surface UA1 of the base substrate SUB which is processed has a first width W1 smaller than a second width W2 of the first lower surface BA1 of the base substrate SUB. In an embodiment, the upper surface and the side surface SA1 are adjacent to each other along a first direction, the upper surface and the lower surface of the base substrate SUB each has a width along the first direction, and the width of the upper surface is smaller than the width of the lower surface.

The side surface SA1 may have a third width along the first directional axis DR1 taken from an end of the first upper surface UA1 to a corresponding end of the first lower surface BA1. The width of the side surface SA1 of the base substrate SUB which is processed gradually decreases in a direction from the first lower surface BA1 to the first upper surface UA1.

The processing of the protective film PF (S502) includes providing or forming an exposed side surface SA2 disposed between the attachment surface CA and an exposed upper surface DCA of the protective film PF which is processed. The exposed side surface SA2 connects the attachment surface CA to the exposed upper surface DCA. The exposed upper surface DCA of the protective film PF is disposed closer to the second lower surface BA2 than the second upper surface UA2 or the attachment surface CA defined between the base substrate SUB and the protective film PF. A width of the protective film PF at the exposed side surface SA2 may increase as a distance from the exposed upper surface DCA decreases, however, is not limited thereto.

The protective film PF includes an overlap portion SPP that overlaps or corresponds to the base substrate SUB which is processed and a non-overlap portion NSPP that does not overlap or correspond to the base substrate SUB which is processed. The non-overlap portion NSPP extends further than an end of the base substrate SUB which is processed, that is, further than the first lower surface BA1. In an embodiment, the processed protective film includes the overlap portion SPP which corresponds to the width of the first lower surface BA1 of the processed base substrate, a non-overlap portion NSPP which extends further than the width of the first lower surface BA1 of the processed base substrate and defines the exposed upper surface DCA of the processed protective film, and an exposed side surface SA2 which connects the exposed upper surface DCA to the second upper surface UA2.

The non-overlap portion NSPP is provided in plural disposed at opposite sides of the protective film PF which is processed, with the overlap portion SPP interposed therebetween. The non-overlap portion NSPP is exposed to outside the base substrate SUB by the processing of the base substrate SUB and the protective film PF. The non-overlap portion NSPP is a portion of the protective film PF which is recessed in a direction toward the second lower surface BA2 of the protective film PF with respect to the attachment surface CA. The exposed upper surface DCA corresponds to an upper surface of the non-overlap portion NSPP.

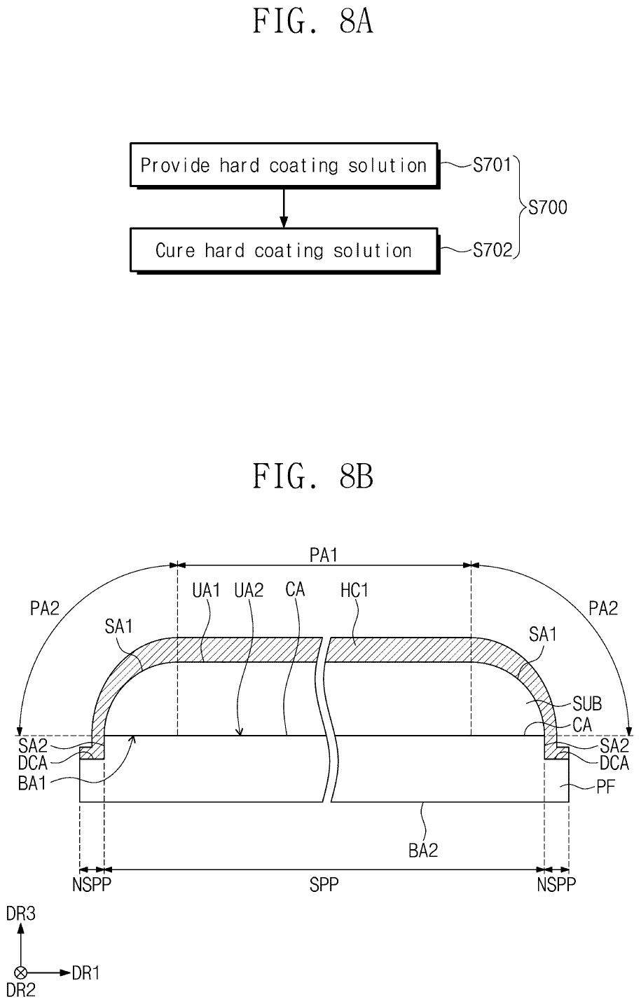

FIG. 8A is a flowchart showing an embodiment of the providing of the first hard coating layer HC1 (S700), and FIG. 8B is a cross-sectional view showing an embodiment of the base substrate SUB and the protective film PF which are processed and to which the first hard coating layer HC1 as a first surface protection layer is provided according to FIG. 8A.

Referring to FIG. 8A, the providing of the first hard coating layer HC1 includes providing a hard coating solution (S701) as a protection layer material and curing the hard coating solution (S702). The providing of the hard coating solution includes providing the hard coating solution such as by a spraying method or a slit coating method. The curing of the hard coating solution includes a heat-curing or an ultraviolet-curing process.

Referring to FIG. 8B, the first hard coating layer HC1 is provided to overlap the upper and side surfaces UA1 and SA1 of the base substrate SUB, the exposed side surface SA2 of the protective film PF and the exposed upper surface DCA of the protective film PF. The exposed upper surface DCA of the protective film PF is disposed closer to the second lower surface BA2 of the protective film PF than the attachment surface CA is, and thus, the first hard coating layer HC1 covers the side surface SA1. That is, the first hard coating layer HC1 may have a thickness which prevents the window WM from being damaged due to external impacts. A thickness of the first hard coating layer HC1 may be taken in a direction normal to a respective surface among the upper and side surfaces UA1 and SA1 of the base substrate SUB, the exposed side surface SA2 of the protective film PF and the exposed upper surface DCA of the protective film PF.

In an embodiment, when the base substrate SUB is processed alone or separately from the protective film PF, or when the exposed upper surface DCA is provided in the protective film PF without reference from the attachment surface CA, the hard coating solution is not fixed on the curved surface, and providing of the hard coating layer HC having a thickness sufficient for protecting the side surface SA1 may be impossible.

In comparison, according to one or more embodiment of the method of providing the window WM, the hard coating solution is coated extending from the base substrate SUB and to the exposed upper surface DCA of the protective film PF to stably provide the hard coating solution on an entirety of the side surface SA1 of the base substrate SUB. Thus, the first hard coating layer HC1 as cured hard coating solution is provided on an entirety of the side surface SA1 that is the curved surface of the window WM.

A first portion PA1 of the first hard coating layer HC1 has a uniform thickness taken in a direction normal to the base substrate SUB which is processed. The thickness of a second portion PA2 of the first hard coating layer HC1 is not uniform taken in a direction normal to a respective surface covered by the hard coating layer HC. However, the invention should not be limited thereto or thereby. That is, the thickness of the first portion PA1 may not be uniform, and the thickness of the second portion PA2 may be uniform. In an embodiment, both the thickness of the first portion PA1 and the thickness of the second portion PA2 may be uniform or may not be uniform.

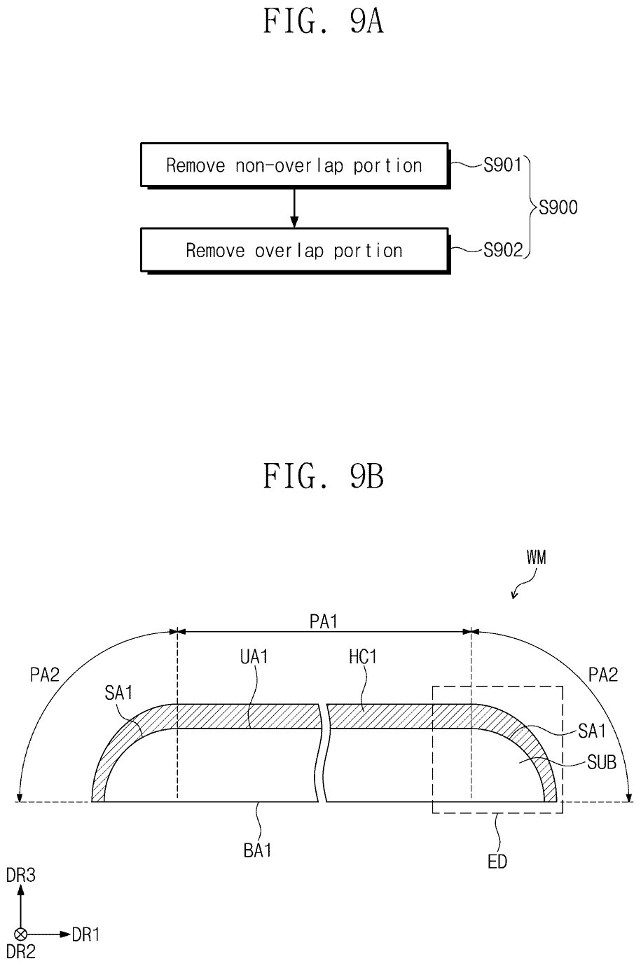

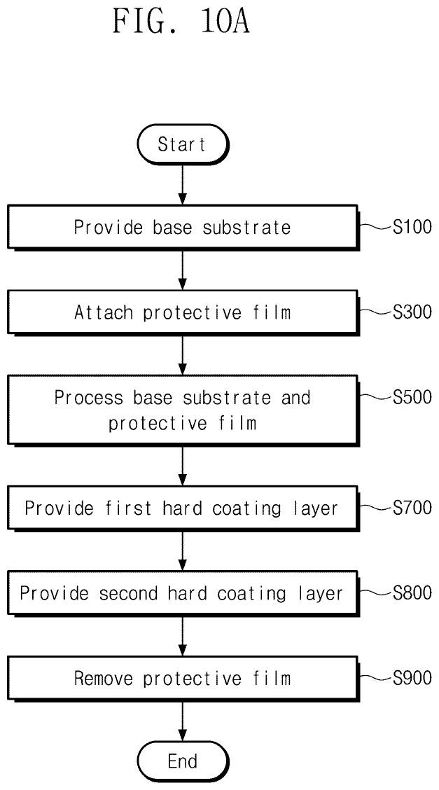

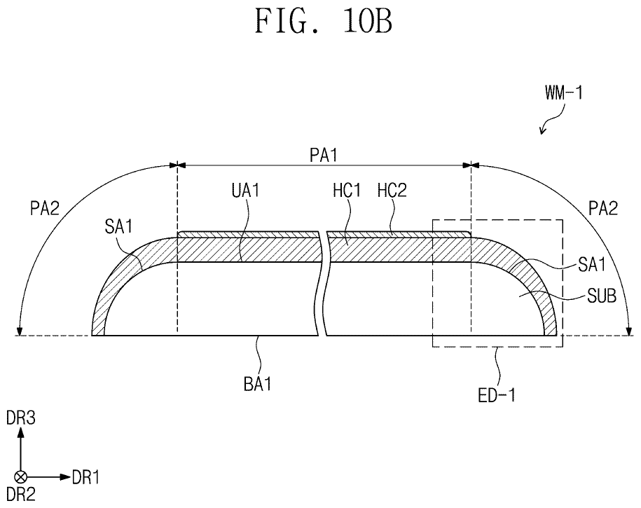

FIG. 9A is a flowchart showing an embodiment of providing the processed protective film separated from the processed base substrate (S900), and FIG. 9B is a cross-sectional view showing an embodiment of a base substrate SUB which is processed and having the first hard coating layer HC1 and from which the protective film PF which is processed is separated.

Referring to FIGS. 9A and 9B, the removing of the protective film PF which is processed (S900) includes removing the non-overlap portion NSPP (S901) and removing the overlap portion SPP (S902). In an embodiment, the non-overlap portion NSPP is removed such as by being separated from a remainder of the protective film PF in a direction opposite to the third directional axis DR3. The removing of the overlap portion SPP may be performed by detaching the protective film PF from the base substrate SUB. The non-overlap portion NSPP of the protective film PF may be removed together with a portion of the first hard coating layer HC1 at the exposed side surface SA2 and at the exposed upper surface DCA of the protective film PF. However, the non-overlap portion NSPP and the overlap portion SPP of the protective film PF may be substantially simultaneously removed from the base substrate SUB.

As the protective film PF is removed from the base substrate SUB, the window WM that includes the first hard coating layer HC1 disposed on the upper and side surfaces UA1 and SA1 of the base substrate SUB may be provided.

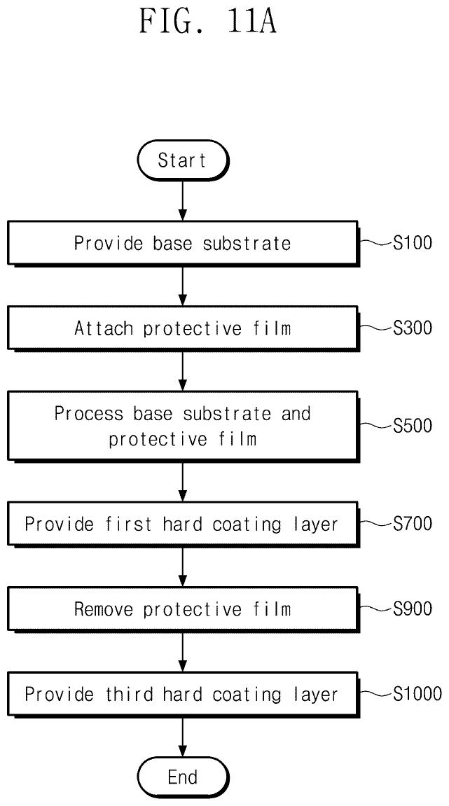

Hereinafter, a method of providing a window WM-1 will be described with reference to FIGS. 10A and 10B. In FIGS. 10A and 10B, detailed descriptions of the same components as mentioned above with reference to FIGS. 1 to 9B may be omitted, and different features will be mainly described.

FIG. 10A is a flowchart showing an embodiment of a method of providing the window WM-1. FIG. 10B shows a structure in which a second hard coating layer HC2 as a second surface protection layer is provided in a process of the method of providing the window WM-1.

Referring to FIGS. 10A and 10B, the method of providing the window WM-1 further includes providing a second hard coating layer HC2 (S800) in addition to the processes in the method of providing the window WM described earlier.

The providing of the second hard coating layer HC2 (S800) is performed by providing the second hard coating layer HC2 on the first hard coating layer HC1. That is, the second hard coating layer HC2 faces the base substrate SUB with the first hard coating layer HC1 therebetween. The second hard coating layer HC2 is provided on the first portion PA1. In an embodiment, the second surface protection layer (e.g., second hard coating layer HC2) is further from the lower surface of the base substrate SUB than the first surface protection layer (e.g., first hard coating layer HC1). The second hard coating layer HC2 may terminate at a boundary between the first portion PA1 and the second portion PA2. The first portion PA1 of the window WM-1 is defined by the second hard coating layer HC2, which overlaps or corresponds to the first upper surface UA1 of the base substrate SUB. The second portion PA2 of the window WM-1 is defined by the first hard coating layer HC1 which overlaps or corresponds to the side surface SA1 of the base substrate SUB.

In an embodiment, the second hard coating layer HC2 is provided by stacking the hard coating layer HC two times on the first upper surface UA1 to secure a hardness which prevents the window WM-1 from being damaged. The structure in FIG. 10B shows a method of stacking two of the hard coating layer HC, however, the invention is not limited thereto. In an embodiment, the hard coating layer HC may include a plurality of sub-coating layers stacked one on another or may be provided in a single-layer structure.

The thickness of the second hard coating layer HC2 is relatively smaller than the thickness of the first hard coating layer HC1, at corresponding locations along the base substrate SUB. The second hard coating layer HC2 has a uniform thickness along the base substrate SUB, however, should not be limited thereto or thereby. In an embodiment, the thickness of the second hard coating layer HC2 may be relatively larger than the thickness of the first hard coating layer HC1, and/or the thickness of the second hard coating layer HC2 may not be uniform.

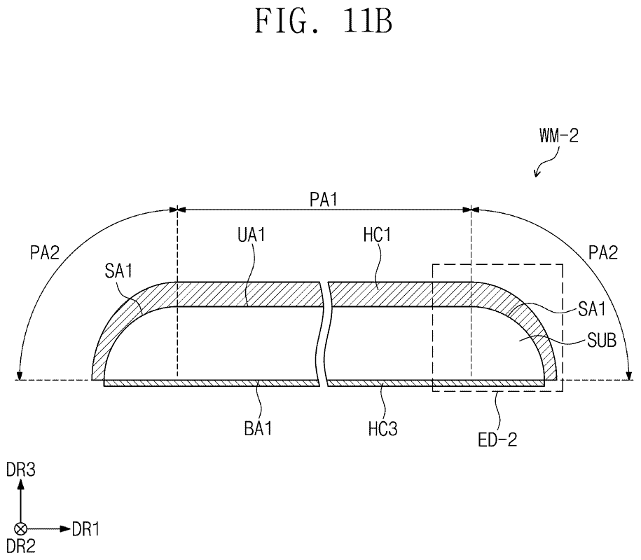

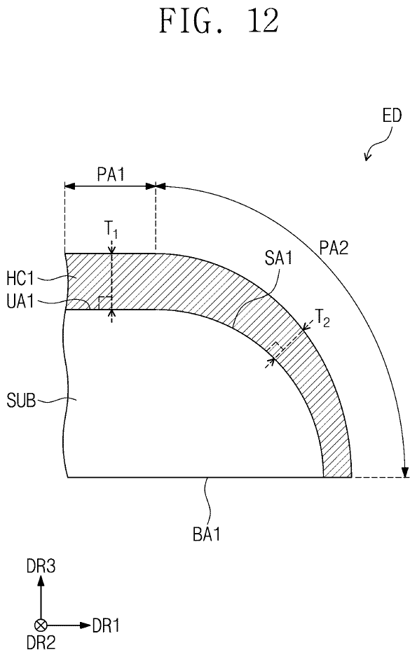

Hereinafter, a method of providing a window WM-2 will be described with reference to FIGS. 11A and 11B. In FIGS. 11A and 11B, detailed descriptions of the same components as mentioned with reference to FIGS. 1 to 9B may be omitted, and different features will be mainly described.

FIG. 11A is a flowchart showing an embodiment of a method of providing the window WM-2. FIG. 11B shows a structure in which a third hard coating layer HC3 as a third surface protection layer is provided in a process of the method of providing the window WM-2.

Referring to FIGS. 11A and 11B, the method of providing the window WM-2 further includes providing a third hard coating layer HC3 (S1000) in addition to the processes in the method of providing the window WM and/or the window WM-1 which are described earlier.

The providing of the third hard coating layer HC3 is performed by providing a coating layer on the first lower surface BA1 of the base substrate SUB. The third hard coating layer HC3 reduces or effectively prevents scratches from being generated when the window WM-2 is combined with the display device DD.

The thickness of the third hard coating layer HC3 is smaller than a thickness of the first hard coating layer HC1 and/or the second hard coating layer HC2. The thickness of the third hard coating layer HC3 is uniform, however, should not be limited thereto or thereby. In an embodiment, the thickness of the third hard coating layer HC3 may be the same as or greater than the thickness of the first hard coating layer HC1 and/or the second hard coating layer HC2, and/or the thickness of the third hard coating layer HC3 may not be uniform.

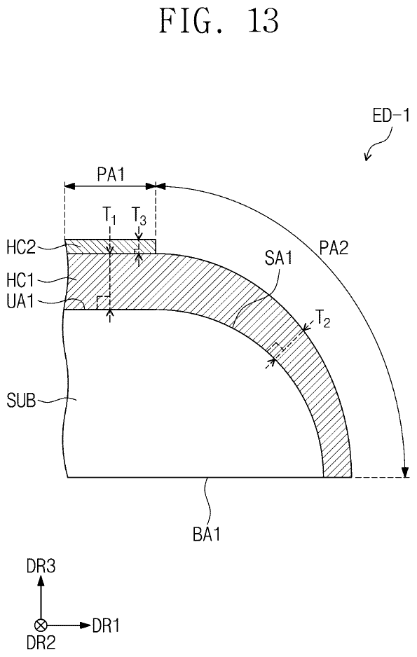

Hereinafter, the window WM will be described in detail with reference to FIGS. 9B, 10B, and 11B, and detailed descriptions of the same components as mentioned earlier may be omitted. FIG. 12 is an enlarged cross-sectional view showing an embodiment of a portion ED of the window WM of FIG. 9B. Hereinafter, the window WM will be described in detail with reference to FIGS. 9B and 12.

The window WM includes the base substrate SUB and the first hard coating layer HC1 which is disposed on the base substrate SUB. The window WM may include only the first hard coating layer HC1, without being limited thereto.

The first hard coating layer HC1 is disposed to overlap or correspond to the first upper surface UA1 and the side surface SA1 of the base substrate SUB. The first hard coating layer HC1 includes a first portion PA1 overlapping the first upper surface UA1 and having a first thickness T1 and a second portion PA2 overlapping the side surface SA1 and having a second thickness T2. The first thickness T1 and the second thickness T2 are minimum distances in a normal line direction with respect to the upper surface and the side surface SA1 of the base substrate SUB, respectively.

The first thickness T1 is greater than the second thickness T2. A ratio of the second thickness T2 to the first thickness T1 is equal to or greater than about 0.5 and smaller than about 1. The first thickness T1 is equal to or greater than about 20 micrometers and equal to or smaller than about 50 micrometers. The second thickness T2 is equal to or greater than about 10 micrometers and equal to or smaller than about 25 micrometers.

When the first thickness T1 is smaller than about 20 micrometers, the hardness which protects the front surface FS of the window WM is not secured. When the first thickness T1 is greater than about 50 micrometers, the surface hardness increases, however, wrinkles or curls increase due to hardening shrinkage of the hard coating layer HC, and cracks or detachment of the hard coating layer HC occur.

The thickness of the first hard coating layer HC1 may not be uniform within a range from a boundary point between the first portion PA1 and the second portion PA2 to an end point (e.g., distal end) of the second portion PA2. In detail, the second thickness T2 of the second portion PA2 decreases in a direction from the first upper surface UA1 to the first lower surface BA1 of the base substrate SUB.

The first portion PA1 of the first hard coating layer HC1 has the hardness corresponding to a pencil hardness equal to or greater than about 8 H and equal to or smaller than about 9 H. The pencil hardness may be a grade scale of the pencil, which is the hardest and does not damage a surface, obtained when the pencil is moved at an angle of about 45 degrees and with a certain force. When the hardness of the first hard coating layer HC1 is smaller than the pencil hardness of about 8 H, the hardness which provides protection for the window WM is not secured, and protection of the display device DD is difficult. When the hardness of the first hard coating layer HC1 is greater than the pencil hardness of about 9 H, wrinkles or curls are generated due to hardening shrinkage of the hard coating layer HC, and cracks or detachment of the hard coating layer HC occur.

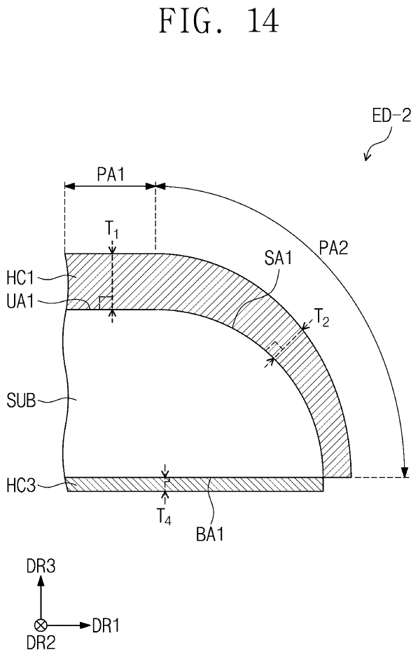

FIG. 13 is an enlarged cross-sectional view showing an embodiment of a portion ED-1 of the window WM-1 of FIG. 10B. Hereinafter, the window WM-1 will be described in detail with reference to FIGS. 10B and 13.

Referring to FIGS. 10B and 13, descriptions of the base substrate SUB and the first hard coating layer HC1 are the same as those described with reference to FIGS. 9A, 9B and 12, and thus, details thereof will be omitted. Accordingly, the second hard coating layer HC2 of FIGS. 10B and 13 will be mainly described.

Referring to FIG. 10B, the window WM-1 includes the second hard coating layer HC2 disposed on the first portion PAI of the first hard coating layer HC1. The first portion PA1 corresponds to a portion in which the first hard coating layer HC1 is in contact with the first upper surface UA1. As being in contact, the first hard coating layer HC1 and the first upper surface UA1 form an interface therebetween.

Additionally stacking the second hard coating layer HC2 on the first hard coating layer HC1 may define a hardness of the window WM-1. In FIGS. 10B and 13, the method of stacking two hard coating layers is shown, however, should not be limited thereto. In an embodiment, the hard coating layer HC may collectively include a plurality of sub-coating layers stacked one on another or may be provided in a single-layer structure.

Referring to FIG. 13, the first hard coating layer HC1 has the first thickness T1, and the second hard coating layer HC2 has a third thickness T3. In FIGS. 10B and 13, the first thickness T1 is shown to be greater than the third thickness T3, however, should not be limited thereto or thereby. In an embodiment, the first thickness T1 may be smaller than the third thickness T3, or the first thickness T1 and the third thickness T3 may be substantially the same as each other.

FIG. 14 is an enlarged cross-sectional view showing an embodiment of a portion ED-2 of the window WM-2 of FIG. 11B. Hereinafter, the window WM-2 will be described in detail with reference to FIGS. 11B and 14.

Referring to FIGS. 11B and 14, descriptions of the base substrate SUB and the first hard coating layer HC1 are the same as those described with reference to FIGS. 9A, 9B and 12, and thus, details thereof will be omitted. Accordingly, the third hard coating layer HC3 in FIGS. 11B and 14 will be mainly described.

Referring to FIG. 11B, the window WM-2 further includes the third hard coating layer HC3 disposed on the first lower surface BA1 of the base substrate SUB. The third hard coating layer HC3 reduces or effectively prevents scratches from being generated when the window WM-2 is combined with the display device DD.

The third hard coating layer HC3 may be a hard coating layer HC which is disconnected from the first hard coating layer HC1. FIG. 14 illustrates the third hard coating layer HC3 only on the first lower surface BA1 of the base substrate SUB and excluded from the side surface SA1 thereof, however, should not be limited thereto.

In an embodiment, the third hard coating layer HC3 may extend in a direction substantially parallel to the first directional axis DR1 and further than the first lower surface BA1 to correspond to a bottom end surface of the first hard coating layer HC1 or the first hard coating layer HC1 may extend in a direction substantially parallel to the third directional axis DR3 and further than the first lower surface BA1 to correspond to an edge surface of the third hard coating layer HC3. Thus, the first hard coating layer HC1 and the third hard coating layer HC3 may be in contact with each other (e.g., form an interface therebetween) to form one continuous layer of hard coating layer HC.

The third hard coating layer HC3 has a fourth thickness T4 that is uniform. The fourth thickness T4 of the third hard coating layer HC3 is smaller than the first thickness T1 of the first hard coating layer HC1, however,, should not be limited thereto or thereby. The fourth thickness T4 of the third hard coating layer HC3 may not be uniform, or may be the same as or greater than the first thickness T1 of the first hard coating layer HC1. In an embodiment, the fourth thickness may be equal to or greater than about 1 micrometer and equal to or smaller than about 10 micrometers.

As described above, the exposed upper surface DCA is disposed closer to the second lower surface BA2 than the attachment surface CA between the protective film PF and the base substrate SUB. Thus, the method of providing the window WM in which the hard coating layer HC protects the side surface SA1 of the base substrate SUB is provided.

As the window WM includes the hard coating layer HC disposed to overlap the entire surface of the side surface SA1, a side surface portion the display device DD, which is curved and covered by a curved portion of the window WM may be protected.

Although embodiments have been described, it is understood that the disclosure should not be limited to these embodiments but various changes and modifications can be made by one ordinary skilled in the art within the spirit and scope of the disclosure as hereinafter claimed.

Therefore, the disclosed subject matter should not be limited to any single embodiment described herein, and the scope of the invention shall be determined according to the attached claims.

What is claimed is:

1. A method of providing a window of an electronic apparatus, comprising:
providing a base substrate comprising a first upper surface and a first lower surface opposing the first upper surface;
providing a protective film comprising a second upper surface and a second lower surface opposing the second upper surface;
providing the second upper surface of the protective film removably attached to the first lower surface of the base substrate;
providing a processed base substrate and a processed protective film by removing a portion of the base substrate and a portion of the protective film to provide an exposed upper surface of the processed protective film which is closer to the second lower surface of the protective film than the second upper surface of the protective film;
providing a first surface protection layer on both the first upper surface of the processed base substrate and the exposed upper surface of the processed protective film; and
providing the processed protective film separated from the processed base substrate to provide the window which is attachable to a display device of the electronic apparatus and includes the processed base substrate having the first surface protection layer.

2. The method of claim 1, wherein the removing of the portion of the base substrate and the portion of the protective film comprises:
defining within the processed base substrate:
a width of the first upper surface which is smaller than a width of the first lower surface, and
a side surface which connects the first upper surface and the first lower surface to each other; and
defining within the processed protective film:
an overlap portion which corresponds to the width of the first lower surface of the processed base substrate,
a non-overlap portion which extends further than the width of the first lower surface of the processed base substrate and defines the exposed upper surface of the processed protective film, and
an exposed side surface which connects the exposed upper surface to the second upper surface.

3. The method of claim 2, wherein the providing of the first surface protection layer comprises:
providing a protection layer material on the first upper surface and the side surface of the processed base substrate and on the non-overlap portion and the exposed side surface of the processed protective film; and
curing the protection layer material.

4. The method of claim 3, wherein the providing of the protection layer material comprises a spraying method or a slit coating method.

5. The method of claim 3, wherein the curing of the protection layer material comprises a heat curing method or an ultraviolet curing method.

6. The method of claim 2, wherein the providing of the processed protective film separated from the processed base substrate comprises separating the non-overlap portion and the overlap portion from the processed base substrate.

7. The method of claim 1, further comprising after the providing of the first surface protection layer, providing a second surface protection layer on the first surface protection layer,
wherein the second surface protection layer is further from the first lower surface of the processed base substrate than the first surface protection layer.

8. The method of claim 1, further comprising after the providing of the processed protective film separated from the processed base substrate, providing a third coating layer on the first lower surface of the processed base substrate.
